(19) United States
(12) Patent Application Publication
(10) Pub. No.: US 2011/0173947 A1
(43) Pub. Date: Jul. 21, 2011

(54) SYSTEM AND METHOD FOR GAS TURBINE POWER AUGMENTATION

(75) Inventors: JIANMIN ZHANG, GREER, SC (US); LISA KAMDAR AMMANN, SIMPSONVILLE, SC (US); BRADLY AARON KIPPEL, GREER, SC (US); HUA ZHANG, GREER, SC (US); JAMES PATRICK TOMEY, SIMPSONVILLE, SC (US)

(73) Assignee: GENERAL ELECTRIC COMPANY, SCHENECTADY, NY (US)

(21) Appl. No.: 12/689,544

(22) Filed: Jan. 19, 2010

(51) Int. Cl. F02C 7/12; F02K 99/00; F01K 13/02

(52) U.S. Cl. 60/39.83; 137/15.2; 60/660

(57) ABSTRACT

A gas turbine power augmentation system and method are provided. The system includes a chiller, a controller, a heat exchanger, and a gas turbine inlet air flow. The chiller may be operable to chill a coolant flow using energy from a heat source. The controller may be operably connected to the chiller and configured to regulate operation of the chiller in relation to at least one environmental condition. The heat exchanger may be in fluid communication with the chiller and configured to allow the coolant flow to pass through the heat exchanger. The gas turbine inlet air flow may be directed through the heat exchanger before entering a gas turbine inlet, allowing the air flow to interact with the coolant flow, thereby cooling the air flow.

### FIELD OF THE INVENTION

The subject matter disclosed herein relates generally to gas turbines, and more specifically to methods and apparatus for operating gas turbines.

### BACKGROUND OF THE INVENTION

Gas turbines are widely utilized in fields such as power generation. A conventional gas turbine system includes a compressor, which compresses ambient air; a combustion chamber, for mixing compressed air with fuel and combusting the mixture; and a turbine, which is driven by the combustion mixture to produce power and exhaust gas.

Various strategies are known in the art for increasing the amount of power that a gas turbine is able to produce. One way of increasing the power output of a gas turbine is by cooling the inlet air before compressing it in the compressor. Cooling causes the air to have a higher density, thereby creating a higher mass flow rate into the compressor. The higher mass flow rate of air into the compressor allows more air to be compressed, allowing the gas turbine to produce more power. Additionally, cooling the inlet air temperature increases the efficiency of the gas turbine.

Various systems and methods have been designed and implemented to cool inlet air for effective and efficient gas turbine operation. One such system cools the air through latent, or evaporative, cooling. This type of system uses water at ambient temperature to cool the air by running the water over plates or over a cellular media inside of a chamber and then drawing air through the chamber. Evaporative cooling can cool the incoming air to near its wet bulb temperature. Evaporative cooling can be an efficient method of cooling inlet air because only a minimal amount of parasitic power is required to run an evaporative cooling system.

However, in many situations, evaporative cooling is not an effective and efficient method for cooling turbine inlet air. For example, evaporative cooling does not work well in relatively humid climates. Additionally, the amount of cooling that can be done using an evaporative cooling method with ambient water may be minimal as compared to other methods, thus resulting in smaller increases of power generated by the gas turbine.

Other such systems cool the air through sensible cooling. These types of systems typically use mechanical chillers to chill water and then run this water through inlet chiller coils. Air is drawn through the coil to cool the air. These systems can be effective because they can cool inlet air to levels well below those attainable using latent cooling methods, such as to below the wet bulb temperature, allowing the gas turbine to produce significantly more power. Additionally, these systems can be utilized in relatively humid climates.

However, in many situations, sensible cooling methods are not effective and efficient methods for cooling turbine inlet air. For example, the parasitic power necessary to operate mechanical chillers and inlet chiller coil systems could be substantial. Thus, a certain amount of the increased gas turbine power production resulting from use of the system would be required to drive the system. Additionally, capital costs for a mechanical chiller plant and inlet chiller coil system large enough to handle the flow rates of air through gas turbines are significant and may be prohibitive. Further, chiller coil systems typically require cooling substance flows that are cooled to temperatures of below 40° F. in order to provide sufficient cooling of inlet air. Finally, a chiller coil imposes a significant pressure drop upon the gas turbine inlet flow, which represents a substantial power generation loss when the coil is not in operation.

Thus, a system that can sufficiently cool inlet air in a wide variety of environmental conditions, does not require prohibitive capital costs, imposes a smaller pressure drop, and does not require substantial parasitic power to operate, may be beneficial. Further, a system and method for cooling gas turbine inlet air that uses latent cooling or sensible cooling as desired to provide optimal gas turbine effectiveness and efficiency in a wide variety of environmental conditions may also be beneficial.

### BRIEF DESCRIPTION OF THE INVENTION

Aspects and advantages of the invention will be set forth in part in the following description, or may be obvious from the description, or may be learned through practice of the invention.

In one embodiment, a gas turbine power augmentation system is provided that includes a chiller, a controller, a heat exchanger, and a gas turbine inlet air flow. The chiller may be operable to chill a coolant flow using energy from a heat source. The controller may be operably connected to the chiller and configured to regulate operation of the chiller in relation to at least one environmental condition. Regulating operation of the chiller may include operating the chiller to chill the coolant flow when the environmental condition is at a first environmental condition level and not operating the chiller to chill the coolant flow when the environmental condition is at a second environmental condition level. The heat exchanger may be in fluid communication with the chiller and configured to allow the coolant flow to pass through the heat exchanger. The gas turbine inlet air flow may be directed through the heat exchanger before entering a gas turbine inlet, allowing the air flow to interact with the coolant flow, thereby cooling the air flow.

In another embodiment, a method for gas turbine power augmentation is provided that includes measuring at least one environmental condition, regulating operation of a chiller in relation to the at least one environmental condition, wherein operation of the chiller chills a coolant flow using energy from a heat source, and communicating the coolant flow through a heat exchanger. Regulating operation of the chiller includes operating the chiller to chill the coolant flow when the environmental condition is at a first environmental condition level and not operating the chiller to chill the coolant flow when the environmental condition is at a second environmental condition level. The heat exchanger may be configured to allow a gas turbine inlet air flow passing through the heat exchanger to interact with the coolant flow, thereby cooling the air flow before the air flow enters a gas turbine inlet.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWING

A full and enabling disclosure of the present invention, including the best mode thereof, directed to one of ordinary skill in the art, is set forth in the specification, which makes reference to the appended FIGURES, in which:

FIG. 1 provides a schematic diagram of the gas turbine power augmentation system of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used with another embodiment to yield a still further embodiment. Thus, it is intended that the present invention covers such modifications and variations as come within the scope of the appended claims and their equivalents.

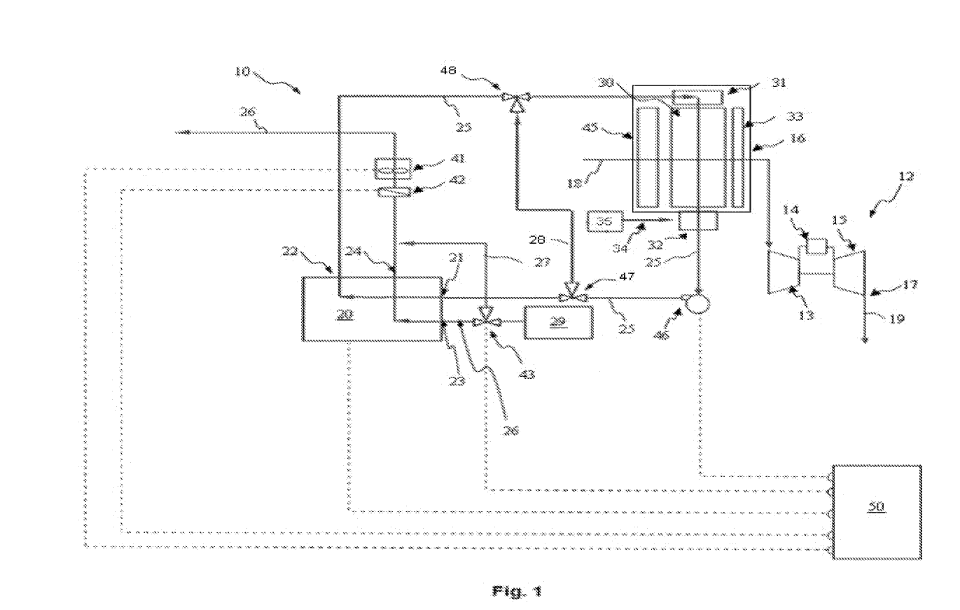

FIG. 1 is a schematic diagram of a gas turbine power augmentation system 10, the system operably connected to a gas turbine 12. The gas turbine 12 may include a compressor 13, combustor 14, and turbine 15. The gas turbine 12 may further include, for example, more than one compressor, more than one combustor, and more than one turbine (not shown). The gas turbine 12 may include a gas turbine inlet 16. The inlet 16 may be configured to receive gas turbine inlet air flow 18. For example, in one embodiment, the inlet 16 may be a gas turbine inlet house. The gas turbine 12 may further include a gas turbine exhaust outlet 17. The outlet 17 may be configured to discharge gas turbine exhaust flow 19. In one embodiment, the exhaust flow 19 may be directed to a heat recovery steam generator (“HRSG”) (not shown). In another embodiment, the exhaust flow 19 may be dispersed into ambient air. In another embodiment, the exhaust flow may be directed to a chiller 20.

The gas turbine power augmentation system 10 may include a chiller 20. The chiller 20 may include coolant inlet 21 and coolant outlet 22 for receiving and discharging coolant flow 25. The chiller 20 may also include heat flow inlet 23 and heat flow outlet 24 for receiving and discharging heat flow 26 from a heat source 29. A bypass valve 43 may be disposed upstream of the chiller 20 in the direction of heat flow 26. Bypass valve 43 may be in communication with heat flow bypass 27. Heat flow bypass 27 may be in communication with heat flow 26 downstream of chiller 20.

The chiller 20 may be operable to chill a coolant flow 25. For example, the chiller 20 may use energy from heat source 29 to chill coolant flow 25. In one embodiment, the chiller 20 may be an absorption chiller. Absorption chillers use heat, instead of mechanical energy, to provide cooling, and utilize a mixture of a solvent and a salt to achieve a refrigeration cycle. For example, water may be used as a refrigerant, and the chiller may rely on a strong affinity between the water and a lithium bromide solution to achieve a refrigeration cycle. The coolant that is chilled may be pure water, or may be water containing glycol, corrosion inhibitors, or other additives. It should be understood, however, that the substance is not limited to water, and may be any other fluid known in the art, such as a thin oil.

Absorption chillers generally have low power requirements compared to mechanical and electrical chillers, and are energy efficient when, for example, waste heat is used as the heat source. For example, in one embodiment, the heat source 29 may be generated by the gas turbine 12. For example, the heat source 29 may be gas turbine exhaust 19. In another embodiment, the heat source 29 may be generated by a HRSG. For example, the heat source 29 may be HRSG water or HRSG steam. In other embodiments, the heat source 29 may be any waste steam, such as steam turbine sealing steam, waste hot water, generator cooling water, or heat flow generated by any heat-producing process. It should be understood that the heat source 29 is not limited to waste heat and exhaust heat sources, but may be supplied through any heating method, such as, for example, solar heating, auxiliary boiler heating or geothermal heating.

It should be understood that the chiller 20 is not limited to an absorption chiller. For example, the chiller may be any chilling machine that removes heat from a liquid via a vapor-compression cycle.

In one embodiment, an exhaust draft device 41 may be disposed downstream of the chiller 20 in the direction of heat flow 26. The exhaust draft device 41 may be configured to communicate heat flow 26 through chiller 20. In one embodiment, an air-bleed device 42 may be disposed downstream of the chiller 20 and upstream of the exhaust draft device 41 in the direction of heat flow 26. Air-bleed device 42 may be configured to allow heat flow 26 to dissipate before reaching exhaust draft device 41. Thus, air-bleed device 42 may act to provide an exhaust draft device 41 working temperature that is lower than the temperature of incoming heat flow 26, insuring reliability and longevity of the exhaust draft device 41.

The gas turbine power augmentation system 10 may further include a heat exchanger 30. The heat exchanger 30 may be in fluid communication with the absorption chiller 20. In one embodiment, the heat exchanger 30 may be configured to allow the coolant flow 25 to pass through the heat exchanger 30. For example, the heat exchanger 30 may include a coolant inlet 31 and a coolant outlet 32. In one embodiment, the coolant inlet 31 may be a nozzle. In another embodiment, the coolant inlet 31 may be a plurality of coolant inlets 31. For example, the coolant inlet 31 may be a plurality of nozzles. The coolant inlet 31 may act to communicate the coolant flow 25 to the heat exchanger 30.

In an exemplary aspect of an embodiment, the coolant outlet 32 may be a sump disposed downstream of the heat exchanger 30 in the direction of coolant flow 25. The sump may be configured to collect the coolant flow 25 after it has passed through the heat exchanger 30, including any resultant condensate from the chilling process.

Heat exchanger 30 may be configured to receive inlet air flow 18. For example, in one embodiment, heat exchanger 30 may be situated upstream of the gas turbine inlet 16 in the direction of inlet air flow 18. In one embodiment, the heat exchanger 30 may be situated adjacent to the gas turbine inlet 16. In another embodiment, the heat exchanger 30 may be situated inside the gas turbine inlet 16. Inlet air flow 18 may be directed through heat exchanger 30 before entering gas turbine inlet 16 or compressor 13.

The heat exchanger 30 may be configured to cool the inlet air flow 18 as the inlet air flow 18 passes through the heat exchanger 30. For example, the heat exchanger 30 may be configured to allow inlet air flow 18 passing through the heat exchanger 30 to interact with the coolant flow 25, thereby cooling the inlet air flow 18. In one embodiment, the inlet air flow 18 may be directed through the coolant flow 25, such that heat is transferred from the inlet air flow 18 to the coolant flow 25, thereby cooling the inlet air flow 18.

In another exemplary aspect of an embodiment, the heat exchanger 30 may be a direct-contact heat exchanger. For example, the heat exchanger 30 may be a media-type direct-contact heat exchanger. The media may be arranged in a structured pattern, a random pattern, or in any pattern known in the art. The media may comprise cellulose-based media, plastic-based media, metal-based media, ceramic-based media, or any media or combination of media known in the art. In one embodiment, coolant flow 25 may be directed in a generally downward direction over the media surface. In one embodiment, the inlet air flow 18 may be directed through the heat exchanger 30 in a direction substantially perpendicular to the direction of the coolant flow 25.

In a further exemplary aspect of an embodiment, a filter 45 may be disposed upstream of the heat exchanger 30 in the direction of inlet air flow 18. The filter 45 may be configured to remove particulate from the inlet air flow 18 prior to the inlet air flow 18 entering the heat exchanger 30 and the gas turbine 12. In another embodiment, a filter 45 may be disposed downstream of the heat exchanger 30 in the direction of inlet air flow 18. The filter 45 may be configured to remove particulate from the inlet air flow 18 prior to the inlet air flow 18 entering the gas turbine 12. In one embodiment, a drift eliminator 33 may be disposed downstream of the heat exchanger 30 in the direction of inlet air flow 18. The drift eliminator 33 may act to remove droplets of coolant from the gas turbine inlet air flow 18 prior to the gas turbine inlet air flow 18 entering the gas turbine 12. In one embodiment, a pump 46 may be disposed downstream of the heat exchanger 30 in the direction of coolant flow 25. The pump 46 may be configured to communicate coolant flow 25 from the heat exchanger 30 to the chiller 20.

The gas turbine power augmentation system 10 may be configured such that operation of the system 10 is regulated in relation to certain conditions: For example, a controller 50 may be operably connected to the gas turbine power augmentation system 10 to regulate the system. In one embodiment, the controller 50 may be operably connected to the chiller 20 and configured to regulate operation of the chiller 20. The controller 50 may be programmed with various control algorithms and control schemes to operate and regulate gas turbine power augmentation system 10 and chiller 20.

The controller 50 may further be operably connected to other elements of the gas turbine power augmentation system 10 or the gas turbine 12. In one embodiment, the controller 50 may be operably connected to bypass valve 43. In other embodiments, the controller 50 may be operably connected to exhaust draft device 41, air-bleed device 42, and pump 46. The controller 50 may be configured to manipulate exhaust draft device 41, air-bleed device 42, bypass valve 43 and pump 46 to maximize the output or efficiency of gas turbine 12. In other embodiments, the controller 50 may be operably connected to other components of the gas turbine power augmentation system 10 or the gas turbine 12 to maximize the output or efficiency of gas turbine 12.

The controller 50 may be configured to monitor at least one environmental condition. The controller 50 may further be configured to regulate operation of the chiller 20 in relation to the at least one environmental condition. For example, in one embodiment, operation of the chiller 20 may be regulated in relation to the ambient relative humidity of the air surrounding the gas turbine 12. Regulating operation of the chiller 20 may include operating the chiller 20 to chill coolant flow 25 when an environmental condition is at a first environmental condition level and not operating the chiller 20 to chill coolant flow 25 when the environmental condition is at a second environmental condition level. For example, in one embodiment, the first environmental condition level may be a first ambient relative humidity level, and the second environmental condition level may be a second ambient relative humidity level. Thus, in an exemplary aspect of an embodiment, the controller 50 may regulate operation of the chiller 20 such that the chiller 20 is operated to chill the coolant flow 25 when the ambient relative humidity is at a first ambient relative humidity level and not operated to chill the coolant flow 25 when the ambient relative humidity is at a second ambient relative humidity level. In one embodiment, the first ambient relative humidity level may be an ambient relative humidity at or above 50%, and the second ambient relative humidity level may be an ambient relative humidity below 50%. In other embodiments, the first ambient relative humidity level may be an ambient relative humidity at or above any relative humidity level in the range of from 40% to 60%, and the second ambient relative humidity level may be an ambient relative humidity below any relative humidity level in the range of from 40% to 60%.

In another exemplary aspect of an embodiment, operation of the chiller 20 may be regulated such that the chiller 20 is operated to chill the coolant flow 25 when the ambient relative humidity is at or above a fixed ambient relative humidity level and not operated to chill the coolant 25 when the ambient relative humidity is below the fixed ambient relative humidity level. In one embodiment, the fixed ambient relative humidity level may be 50%. In other embodiments, the fixed ambient relative humidity level may be any relative humidity level in the range of from 40% to 60%,

In an exemplary aspect of an embodiment, the chiller 20 may be regulated such that the inlet air flow 18 passing through heat exchanger 30 may be cooled primarily through sensible cooling when the environmental condition is at a first environmental condition level and cooled primarily through latent cooling when the environmental condition is at a second environmental condition level. For example, in one embodiment, operation of the chiller 20 may be regulated such that the chiller 20 is operated to chill the coolant flow 25 when the ambient relative humidity is at a first ambient relative humidity level. During these conditions, inlet air flow 18 passing through heat exchanger 30 may be cooled primarily through sensible cooling. Further, chiller 20 may be not operated to chill the coolant flow 25 when the ambient relative humidity is at a second ambient relative humidity level. During these conditions, inlet air flow 18 passing through heat exchanger 30 may be cooled primarily through latent cooling. In one embodiment, the first ambient relative humidity level may be an ambient relative humidity at or above 50%, and the second ambient relative humidity level may be an ambient relative humidity below 50%. In other embodiments, the first ambient relative humidity level may be an ambient relative humidity at or above any relative humidity level in the range of from 40% to 60%, and the second ambient relative humidity level may be an ambient relative humidity below any relative humidity level in the range of from 40% to 60%.

In another exemplary aspect of an embodiment, operation of the chiller 20 may be regulated such that the chiller 20 is operated to chill the coolant flow 25 when the ambient relative humidity is at or above a fixed ambient relative humidity level. During these conditions, inlet air flow 18 passing through heat exchanger 30 may be cooled primarily through sensible cooling. Further, chiller 20 may be not operated to chill the coolant flow 25 when the ambient relative humidity is below the fixed ambient relative humidity level. During these conditions, inlet air flow 18 passing through heat exchanger 30 may be cooled primarily through latent cooling. In one embodiment, the fixed ambient relative humidity level may by 50%. In other embodiments, the fixed ambient relative humidity level may be any relative humidity level in the range of from 40% to 60%.

Sensible cooling refers to a method of cooling where heat is removed from air resulting in a change in the dry bulb and wet bulb temperatures of the air. Sensible cooling may involve chilling a cooling substance and then using the chilled cooling substance to cool air. For example, when an environmental condition is at a first environmental condition level, operation of the chiller 20 may be regulated such that the chiller 30 is operated to chill coolant flow 25. With chiller 20 operating to chill coolant flow 25, coolant flow 25 may operate at a temperature below ambient. For example, in one embodiment coolant flow 25 may be chilled water. As coolant flow 25 is communicated through heat exchanger 30, the coolant flow 25 may interact with inlet air flow 18. Coolant flow 25, operating at a temperature below ambient, may act to cool inlet air flow 18 through sensible cooling.

Latent cooling refers to a method of cooling where heat is removed from air resulting in a change in the moisture content of the air. Latent cooling, or evaporative cooling, may involve the evaporation of a liquid substance at ambient temperature to cool air. For example, when an environmental condition is at a second environmental condition level, operation of the chiller 20 may be regulated such that the chiller 20 is not operated to chill coolant flow 25. In one embodiment, heat flow 26 may be communicated through bypass valve 43 to bypass chiller 20, thus inhibiting the chilling operation of chiller 20. In another embodiment, chiller 20 may be taken out of operation such that coolant flow 25 flows through chiller 20 but heat flow 26 does not chill the coolant flow 25. In still another embodiment, coolant flow 25 may bypass the chiller 20 via valve 47, and may flow through coolant bypass 28 and valve 48 to coolant inlet 31. Because the coolant flow 25 may interact with inlet air flow 18, evaporating into inlet air flow 18, a make-up coolant flow 34 may be added to the coolant flow 25 from independent coolant source 35, to compensate for the loss of coolant 25. Without chiller 20 operating to chill coolant flow 25, coolant flow 25 may operate at ambient temperature. For example, in one embodiment, coolant flow 25 may be water at ambient temperature. As coolant flow 25 is communicated through heat exchanger 30, the coolant flow 25 may interact with inlet air flow 18. Coolant flow 25, operating at ambient temperature, may act to cool inlet air flow 18 through latent or evaporative cooling.

It should be understood that latent cooling and sensible cooling are not mutually exclusive cooling methods. For example, in one embodiment, when the coolant flow 25 is chilled to a temperature below ambient, the inlet air flow 18 may be cooled through sensible cooling only. In another embodiment, when the coolant flow 25 is at ambient temperature, the inlet air flow 18 may be cooled through latent cooling only. In another embodiment, such as during a transition in the temperature of the coolant flow 25 from below ambient to ambient or from ambient to below ambient, such as immediately before or immediately after the chiller 20 is operated, the inlet air flow 18 may be cooled through both sensible cooling and latent cooling. Thus, the gas turbine power augmentation system 10 of the present disclosure can provide both sensible cooling and latent cooling of inlet air flow 18, and these methods can be applied both exclusively and in combination.

Regulation of the gas turbine power augmentation system 10 and chiller 20 is not limited to regulation in relation to the ambient relative humidity of air. For example, the gas turbine power augmentation system 10 and chiller 20 may be regulated in relation to the temperature of the inlet air flow 18 downstream of the heat exchanger 30. In an exemplary aspect of an embodiment, the chiller 20 may be regulated to adjust or maintain the temperature of the inlet air flow 18 downstream of the heat exchanger 30 in a desired temperature range. For example, the chiller 20 may be regulated such that the inlet air flow 18 passing through heat exchanger 30 may be cooled primarily through sensible cooling when the temperature of air downstream of the heat exchanger 30 is at a first level and primarily through latent cooling when the temperature of air downstream of the heat exchanger 30 is at a second level.

Further, regulation of the gas turbine power augmentation system 10 and chiller 20 may include regulating chiller 20 to provide various levels of chilling of the coolant flow 25. For example, in one embodiment, operation of the chiller 20 may be regulated to control the temperature of the coolant flow 25. In another embodiment, operation of the chiller 20 may be regulated to control the flow rate of the coolant flow 25. Thus, for example, the temperature and flow rate of coolant flow 25 can be adjusted such that the inlet air flow 18 downstream of the heat exchanger 30 can be cooled primarily through sensible cooling to a set-point temperature despite changes in the ambient relative humidity of the inlet air flow 18 upstream of the heat exchanger 30. Further, in one embodiment, operation of the chiller 20 may be regulated to control the flow rate of the coolant flow 25 such that, for example, inlet air flow 18 downstream of the heat exchanger 30 can be cooled primarily through latent cooling to a set-point temperature despite changes in the ambient relative humidity of the inlet air flow 18 upstream of the heat exchanger 30.

In an exemplary aspect of an embodiment, regulation of the gas turbine power augmentation system 10 and chiller 20 by the controller 50 can be overridden to manage operating conditions. For example, regulation of chiller 20 can be overridden to manage grid stability, such as of a grid of power plants. For example, in one embodiment, regulation of the chiller 20 can be overridden to operate to chill coolant flow 25 under any environmental condition, such that coolant flow 25 acts to cool inlet air flow 18 primarily through sensible cooling under any environmental condition. In this embodiment, the gas turbine 12 may constantly produce a substantial amount of power, despite being inefficient when certain environmental conditions are present. This power may be used to maintain grid stability. In another embodiment, chiller 20 can be overridden to not operate to chill coolant flow 25 under any environmental condition, such that coolant flow 25 acts to cool inlet air flow 18 primarily through latent cooling under any environmental condition.

The current disclosure also provides a method for augmenting gas turbine power. The method may include measuring at least one environmental condition. As discussed above, in one embodiment the environmental condition may be the ambient relative humidity of air upstream of a heat exchanger 30. In another embodiment the environmental condition may be the temperature of inlet air flow 18 downstream of the heat exchanger 30.

The method may further include regulating operation of a chiller 20 in relation to the at least one environmental condition. As discussed above, operation of the chiller 20 may chill a coolant flow 25. In one embodiment the chiller 20 may be an absorption chiller. In one embodiment, the coolant may be water. In one embodiment, the chiller 20 may use energy from a heat source 29 to chill the coolant flow 25. As discussed above, for example, the heat source 29 may be, HRSG water or HRSG steam. In other embodiments, the heat source 29 may be any waste steam, such as steam turbine sealing steam, waste hot water, generator cooling water or heat flow generated by any heat-producing process.

As discussed above, regulating operation of the chiller 20 may include operating the chiller 20 to chill a coolant flow 25 when an environmental condition is at a first environmental condition level and not operating the chiller 20 to chill the coolant flow 25 when the environmental condition is at a second environmental condition level. For example, in one embodiment, the environmental condition may be the ambient relative humidity of air upstream of the heat exchanger. In one embodiment, the first environmental condition level may be a first ambient relative humidity level, and the second environmental condition level may be a second ambient relative humidity level. In one embodiment, the first ambient relative humidity level may be an ambient relative humidity at or above 50%, and the second ambient relative humidity level may be an ambient relative humidity below 50%. In other embodiments, the first ambient relative humidity level may be an ambient relative humidity at or above any relative humidity level in the range of from 40% to 60%, and the second ambient relative humidity level may be an ambient relative humidity below any relative humidity level in the range of from 40% to 60%.

In an exemplary aspect of an embodiment, regulating operation of the chiller 20 may include operating the chiller 20 to chill a coolant flow 25 when the ambient relative humidity is at or above a fixed ambient relative humidity level, and not operating the chiller 20 to chill coolant flow 25 when the ambient relative humidity is below the fixed ambient relative humidity level. In one embodiment, the fixed ambient relative humidity level may be 50%. In other embodiments, the fixed ambient relative humidity level may be any relative humidity level in the range of from 40% to 60%.

The method may further include communicating a coolant flow 25 through a heat exchanger 30. As discussed above, the heat exchanger 30 may be situated adjacent to or inside of a gas turbine inlet 16. The heat exchanger 30 may be configured to allow inlet air flow 18 passing through the heat exchanger 30 to interact with the coolant flow 25, thereby cooling the inlet air flow 18 before the air flow 18 enters the gas turbine inlet 16 or compressor 13. For example, in one embodiment, the heat exchanger 30 may be a direct-contact heat exchanger.

As discussed above, in an exemplary aspect of an embodiment, regulation of the operation of the chiller 20 by the controller 50 can be overridden. For example, regulation of operation of the chiller 20 may be overridden to manage operating conditions, such as grid stability.

By providing a chiller 20 and heat exchanger 30 in a single gas turbine power augmentation system 10, gas turbine inlet air flow 18 can be cooled using latent cooling and sensible cooling in one system as dictated by environmental conditions. This arrangement provides a gas turbine power augmentation system with substantial flexibility, in that one system is capable of cooling gas turbine inlet air flow 18 using cooling methods appropriate to optimize operation of the gas turbine 12 and provide maximum gas turbine efficiency under all environmental conditions.

For example, in an exemplary aspect of an embodiment, the gas turbine power augmentation system 10 may cool inlet air flow 18 primarily through latent cooling when the ambient relative humidity of air is relatively low, such as below 50%. Latent cooling may provide maximum gas turbine efficiency under these conditions because, for example, only a minimal amount of parasitic power is required to provide latent cooling as opposed to sensible cooling, so there is an increase in net gas turbine power generation efficiency.

However, under other conditions such as when the ambient relative humidity of air is relatively high, such as above 50%, latent cooling is not as effective. Thus, in one embodiment, the gas turbine power augmentation system 10 may cool inlet air flow 18 primarily through sensible cooling when the ambient relative humidity of air is relatively high, such as above 50%. Sensible cooling may provide maximum gas turbine efficiency under these conditions because, for example, latent cooling is not effective under high relative humidity conditions, and sensible cooling can cool the inlet air flow 18 to levels well below those attainable using latent cooling, such as to below the wet bulb temperature, so there is an increase in net gas turbine power output.

Additionally, the combination of a chiller 20 and heat exchanger 30 may decrease the pressure drop of the inlet air flow 18 at gas turbine inlet 16 relative to inlet chiller coil configurations. For example, in one embodiment, the pressure drop can be decreased by approximately 0.5 inches of water column (“w.c.”).

Further, providing a chiller 20 and heat exchanger 30 in a single gas turbine power augmentation system 10 allows cooling of gas turbine inlet air flow 18 using coolant flow 25 at temperatures above those required by inlet chiller coils. Mechanical coil cooling systems typically require cooling substance flows that are cooled to temperatures of below 35° F. The capital costs of mechanical chiller plants and coil systems are significant and may be prohibitive. However, a single gas turbine power augmentation system 10 with a chiller 20 and a heat exchanger 30 as provided only requires cooling substance flows that are cooled to temperatures above 35° F., such as between 35° F. and 50° F., such as between 40° F. and 45° F., such as approximately 43° F. For example, in one embodiment, an absorption chiller 20 and direct-contact heat exchanger 30 may provide sufficient cooling of inlet air flow 18 using a coolant flow 25 at a temperature above 35° F., such as between 35° F. and 50° F., such as between 40° F. and 45° F., such as approximately 43° F. This system 10 provides a significant decrease in the capital costs associated with gas turbine power augmentation systems.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A gas turbine power augmentation system comprising:
a chiller, the chiller operable to chill a coolant flow using energy from a heat source;
a controller operably connected to the chiller and configured to regulate operation of the chiller in relation to at least one environmental condition, wherein regulating operation of the chiller comprises operating the chiller to chill the coolant flow when the environmental condition is at a first environmental condition level and not operating the chiller to chill the coolant flow when the environmental condition is at a second environmental condition level;
a heat exchanger in fluid communication with the chiller and configured to allow the coolant flow to pass through the heat exchanger; and
a gas turbine inlet air flow, wherein the air flow is directed through the heat exchanger before entering a gas turbine inlet, allowing the air flow to interact with the coolant flow, thereby cooling the air flow.

2. The gas turbine power augmentation system of claim 1, wherein the environmental condition is the ambient relative humidity of air upstream of the heat exchanger.

3. The gas turbine power augmentation system of claim 1, wherein the first environmental condition level is an ambient relative humidity of air upstream of the heat exchanger at or above 50%, and the second environmental condition level is an ambient relative humidity of air upstream of the heat exchanger below 50%.

4. The gas turbine power augmentation system of claim 1, wherein the environmental condition is the temperature of air downstream of the heat exchanger.

5. The gas turbine power augmentation system of claim 1, wherein regulation of the operation of the chiller by the controller in relation to at least one environmental condition can be overridden to manage at least one operating condition.

6. The gas turbine power augmentation system of claim 5, wherein the operating condition is grid stability.

7. The gas turbine power augmentation system of claim 1, wherein the air flow is cooled primarily through sensible cooling when the environmental condition is at the first environmental condition level and cooled primarily through latent cooling when the environmental condition is at the second environmental condition level.

8. The gas turbine power augmentation system of claim 1, wherein the chiller is an absorption chiller.

9. The gas turbine power augmentation system of claim 1, wherein the heat exchanger is a direct-contact heat exchanger.

10. The gas turbine power augmentation system of claim 1, wherein the heat source is one of gas turbine exhaust, heat recovery steam generator water, heat recovery steam generator steam, steam turbine sealing steam, waste hot water, or generator cooling water.

11. A gas turbine power augmentation system comprising:
an absorption chiller, the absorption chiller operable to chill a coolant flow using energy from a heat source;
a direct-contact heat exchanger, the direct-contact heat exchanger in fluid communication with the absorption chiller and configured to allow the coolant flow to pass through the direct-contact heat exchanger;
a controller operably connected to the absorption chiller, the controller configured to monitor the ambient relative humidity of air upstream of the direct-contact heat exchanger, to operate the absorption chiller to chill the coolant flow when the ambient relative humidity is at or above a fixed ambient relative humidity level, and to not operate the absorption chiller to chill the coolant flow when the ambient relative humidity is below the fixed ambient relative humidity level; and
a gas turbine inlet air flow, wherein the air flow is directed through the heat exchanger before entering a gas turbine inlet, allowing the air flow to interact with the coolant flow, thereby cooling the air flow,
wherein the air flow is cooled primarily through sensible cooling when the ambient relative humidity is at or above the fixed ambient relative humidity level and cooled primarily through latent cooling when the ambient relative humidity is below the fixed ambient relative humidity level.

12. The gas turbine power augmentation system of claim 11, wherein the fixed ambient relative humidity level is 50%.

13. The gas turbine power augmentation system of claim 11, wherein the heat source is one of gas turbine exhaust, heat recovery steam generator water, heat recovery steam generator steam, steam turbine sealing steam, waste hot water, or generator cooling water.

14. A method for augmenting gas turbine power comprising:
measuring at least one environmental condition;
regulating operation of a chiller in relation to the at least one environmental condition, wherein operation of the chiller chills a coolant flow using energy from a heat source, and wherein regulating operation of the chiller comprises operating the chiller to chill the coolant flow when the environmental condition is at a first environmental condition level and not operating the chiller to chill the coolant flow when the environmental condition is at a second environmental condition level; and
communicating the coolant flow through a heat exchanger, wherein the heat exchanger is configured to allow a gas turbine inlet air flow passing through the heat exchanger to interact with the coolant flow, thereby cooling the air flow before the air flow enters a gas turbine inlet.

15. The method for augmenting gas turbine power of claim 14, wherein the environmental condition is the ambient relative humidity of air upstream of the heat exchanger.

16. The method for augmenting gas turbine power of claim 14, wherein the first environmental condition level is an ambient relative humidity of air upstream of the heat exchanger at or above 50%, and the second environmental condition is an ambient relative humidity of air upstream of the heat exchanger below 50%.

17. The method for augmenting gas turbine power of claim 14, wherein the environmental condition is the temperature of air downstream of the heat exchanger.

18. The method for augmenting gas turbine power of claim 14, wherein the chiller is an absorption chiller.

19. The method for augmenting gas turbine power of claim 14, wherein the heat exchanger is a direct-contact heat exchanger.

20. The method for augmenting gas turbine power of claim 14, wherein the heat source is one of gas turbine exhaust, heat recovery steam generator water, heat recovery steam generator steam, steam turbine sealing steam, waste hot water, or generator cooling water.
